(19) United States
(12) Patent Application Publication
(10) Pub. No.: US 2019/0086148 A1
(43) Pub. Date: Mar. 21, 2019

(54) APPARATUS AND METHOD FOR DRYING HANDS

(71) Applicants: MIKHAIL SHAKHMUROV, Fresh Meadows, NY (US); Gavriol Davydov, Brooklyn, NY (US)

(72) Inventors: MIKHAIL SHAKHMUROV, Fresh Meadows, NY (US); Gavriol Davydov, Brooklyn, NY (US)

(21) Appl. No.: 15/710,461

(22) Filed: Sep. 20, 2017

(51) Int. Cl. F26B 5/02

(52) U.S. Cl. CPC F26B 5/02; A47K 10/00

(57) ABSTRACT

An apparatus for drying hands has an ultrasound generator providing an ultrasound electrical voltage, and a piezoelectric transducer connected to the ultrasound generator and generating acoustic waves which create friction on a surface of hand and thereby dry the hands in a noiseless manner, and a method of drying hands is implemented by the apparatus

### BACKGROUND OF THE INVENTION

The present invention relates to an apparatus for drying hands and a method of drying hands.

Apparatuses and methods for drying hands are known in the art in many varieties. They provide an efficient action which causes drying of hands, for example after washing hands, over a reasonably short period of time. The conventional apparatuses for drying hands are however designed so that due their specific units and components with their cooperation they generate a significant noise, which is quite bothering for users.

It is therefore believed that the existing an apparatuses for drying hands and a methods of drying hands can be further improved.

### SUMMARY OF THE INVENTION

Accordingly, it is an object of the present invention to provide an apparatus for drying hands and a method of drying hands, which are further improvement of the existing apparatuses for drying hands and methods of drying hands.

In keeping with these objects and with others which will become apparent hereinafter, one feature of the present invention resides, briefly stated, in an apparatus for drying hands, which comprises an ultrasound generator providing an ultrasound electrical voltage, and a piezoelectric transducer connected to the ultrasound generator and generating acoustic waves which create friction on a surface of hand and thereby dry the hands

When the apparatus for drying hands is designed in accordance with the present invention, it provides an efficient drying of hands and at the same time operates in a noiseless manner.

According to a further feature of the present invention the apparatus for drying hands is provided with a power supply connectable to a voltage source, and the ultrasound generator is connected to the voltage source.

According to a further feature of the present invention, a method of drying hands is proposed which includes the steps of providing an ultrasound electrical voltage by an ultrasound generator, connecting a piezoelectric transducer to the ultrasound generator for generating acoustic waves which create friction on a surface of hand and thereby dry the hands.

According to a further feature of the present invention the method of drying hands includes providing a power supply connectable to a voltage source and connected with the ultrasound generator.

The novel features of the present invention are set forth in particular in the appended claims.

The invention itself however both as to its construction and its method of operation will be best understood from the following description of the preferred embodiment, which is ac companied by the following drawings.

### BRIEF DESCRIPTION OF THE DRAWINGS

FIG. 1 of the drawings is a single figure illustrating an apparatus for drying hands with all its components according to the present invention, which apparatus implements a method for drying hands according to the present invention in a noiseless manner.

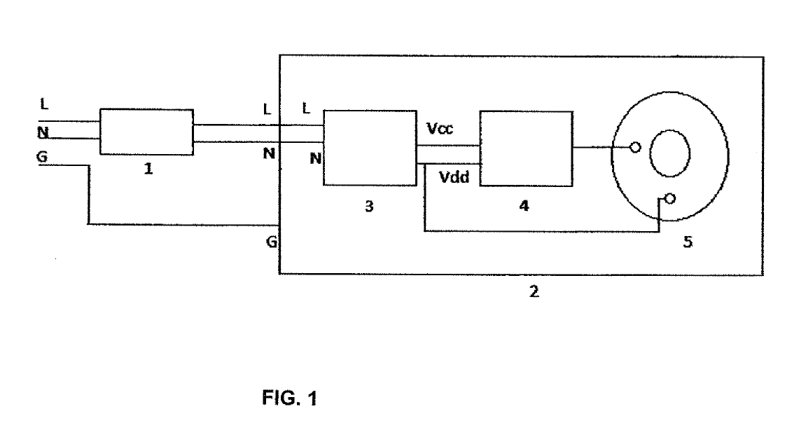

### DESCRIPTION OF THE PREFERRED EMBODIMENTS

An apparatus for drying hands according to the present invention has a ground fault interrupter which is identified with reference numeral The apparatus has further an enclosure 2 which surrounds an encloses all further components of the apparatus for drying hands according to the present invention.

The inventive apparatus for drying hands further has a power supply identified with reference numeral 3 and electrically connectable with the ground fault interrupter 1. An ultrasound generator 4 is further electrically connected with the power supply 3. The apparatus further has a transducer 5 which is electrically connected with the ultrasound generator.

The ground fault interrupter 1 keeps its input L connected with its output L, and a difference of electric currents passing through L and N inputs preferably is less than 5 milliampere, otherwise it breaks the connection between the input L and the output L. The input N is permanently connected to an output N. The power supply 3 is fed with mains voltage 129V 60 Hz and provides DC voltage.

The ultrasound generator 4 provides ultrasound (50-100 kHz) electrical voltage waveform. The piezoelectric transducer changes its volume according to the applied voltage.

In the apparatus there are the following connections. Input L of the ground fault interrupter 1 is connected to electrical main hot line. Input N of the ground fault interrupter 1 is connected to electrical main neutral line. All metal of electrical conductive parts of the enclosure 2 are connected to electrical mains ground line. Output L of the ground fault interrupter is connected to input of the power supply 3. Output N of the ground fault interrupter is connected to the input N of the power supply 3. Output Vcc of the power supply 3 is connected to input Vcc of the ultrasound generator 4. One output of the piezoelectric transducer 5 is connected to the output N of the ultrasound generator 4. Another input of the piezoelectric transducer 5 is connected to output Vdd of the power supply 3.

During the operation of the apparatus for drying hands according to the present invention the ultrasound generator 4 provides an ultrasound electrical voltage, and the piezoelectric transducer 5 connected to the ultrasound generator 4 generates acoustic waves which are such that they create friction on a surface of hands and thereby dry the hands. At the same time the apparatus for drying hands according to the present invention operates in a noiseless manner.

The present invention is not limited to the details shown since various modifications and structural changes are possible without departing from the spirit of the invention.

What is desired to be protected by Letters Patent is set forth in the appended claims.

1. An apparatus for drying hands, which comprising an ultrasonic generator providing an ultrasound electrical voltage, and a piezoelectric transducer connected to the ultrasound generator and generating acoustic waves which create friction on a surface of hand and thereby dry the hands in a noiseless manner.

2. The apparatus of claim 1, further comprising a power supply connectable to a voltage source, wherein the ultrasonic generator is connected to the voltage source.

3. The apparatus of claim 1, further comprising an enclosure which encloses all components of the apparatus.

4. A method of drying hands, comprising the steps of providing an ultrasound electrical voltage by an ultrasonic generator, connecting a piezoelectric transducer to the ultrasound generator for generating acoustic waves which create friction on a surface of hand and thereby dry the hands in a noiseless manner.

5. The method of claim 4, further comprising providing a power supply connectable to a voltage source and connected with the ultrasonic generator.

6. The method of claim 4, further comprising providing an enclosure which encloses all components of the apparatus
